(19) United States
(12) Patent Application Publication
(10) Pub. No.: US 2024/0228845 A1
(43) Pub. Date: Jul. 11, 2024

(54) SINGLE COMPONENT WATERPROOFING COMPOSITION AND USE THEREOF

(71) Applicant: GCP Applied Technologies Inc., Wilmington, MA (US)

(72) Inventors: Peter Kempenaers, Nieuwrode (BE); Malgorzata Podgorska, Hulshout (BE); Pascal Geudens, Olen (BE); Pawel Witczak, Booischot (BE); Jennifer Mazzone, Manchester, MA (US)

(21) Appl. No.: 18/558,836

(22) PCT Filed: May 3, 2022
(86) PCT No.: PCT/US2022/027529

§ 371 Date: Nov. 3, 2023

Related U.S. Application Data
(60) Provisional application No. 63/183,695, filed on May 4, 2021.

(51) Int. Cl. C09J 171/02; C09D 171/02; C08K 3/26; C08K 3/36

(52) U.S. Cl. CPC C09J 171/02; C09D 171/02; C08K 2003/265; C08K 3/36

(57) ABSTRACT

A paste composition, method of use, and building product containing such composition. The composition comprises at least one (preferably two) silyl-terminated polymer resin and a plurality of adhesion promoters. In preferred embodiments, the composition has a paste consistency. In preferred embodiments the paste has a slump between 0 and 20 mm, more preferably a slump between 0 and 10 mm, and most preferably a slump between 0 and 5 mm, and a low water absorption after water immersion. In further exemplary embodiments, the composition further has good bond to dry/damp concrete and other substrates, with and without water immersion.

### FIELD OF THE INVENTION

The invention relates to the field of waterproofing compositions, and more particularly to single component waterproofing pastes.

### BACKGROUND OF THE INVENTION

It is known to form waterproofing membranes and air barrier membranes on building construction surfaces using a liquid coating or paste-like composition. Examples include US2009/0081470 and U.S. Pat. No. 8,481,668. However, a major drawback of conventional compositions is poor adhesion in various conditions, for example to wet and dry concrete, after extended periods of water immersion, and in low temperature environments, among other conditions.

Accordingly, what is needed is a spreadable waterproofing composition with improved adhesion properties. However, in view of the art considered as a whole at the time the present invention was made, it was not obvious to those of ordinary skill in the field of this invention how the shortcomings of the prior art could be overcome.

While certain aspects of conventional technologies have been discussed to facilitate disclosure of the invention, Applicants in no way disclaim these technical aspects, and it is contemplated that the claimed invention may encompass one or more of the conventional technical aspects discussed herein.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

### SUMMARY OF THE INVENTION

The long-standing but heretofore unfulfilled need for an improved waterproofing composition is now met by a new, useful, and nonobvious invention.

In an example embodiment, the invention provides a non-aqueous, moisture-cured waterproofing paste composition, comprising:

a first silyl-terminated reactive polymer resin;

a second silyl-terminated reactive polymer resin, wherein the first silyl-terminated reactive polymer resin has a different chemical structure from the second silyl-terminated reactive polymer resin; and

a plurality of adhesion promoters, each including a functional silane, wherein a first adhesion promoter of the plurality of adhesion promoters comprises a hydrophobic diaminofunctional silane;

wherein the composition, upon curing, has a water absorption of about 15% or less after about 40 days of water immersion.

In preferred embodiments, the non-aqueous moisture-cured waterproofing paste composition has preferably a slump between 0 and 20 mm prior to curing, more preferably a slump between 0 and 10 mm prior to curing; and most preferably a slump between 0 and 5 mm prior to curing, the slump being determined in accordance with ASTM D 2202-00 (2019).

In another example embodiment, the invention provides a waterproofing paste, comprising at least one silyl-terminated polymer resin and a plurality of adhesion promoters, wherein the paste has the following properties:

a cure time at 5° C. under about 24 hours;

peel adhesion to damp concrete at 23° C. between about 0.6 N/mm and about 2.0 N/mm, the peel adhesion being determined in accordance with ASTM D903-98 (2017) (modified); and

a water absorption of about 30% or less after about 40 days of water immersion.

In a preferred waterproofing paste comprising the at least one silyl-terminated polymer resin and a plurality of adhesion promoters, the paste preferably has a slump between 0 and 20 mm prior to curing, more preferably the paste has a slump between 0 and 10 mm prior to curing, and most preferably the paste has a slump between 0 and 5 mm prior to curing; the slump being determined in accordance with ASTM D 2202-00 (2019).

In other embodiments, the current invention is a paste composition comprising a modified silicone (MS) polymer resin, a silane-terminated polyether polymer (STPE) resin, and a trio of silane-functional adhesion promoters. The composition optionally includes plasticizers, catalysts, additives, and fillers, as needed. These compositions can result in various beneficial properties, such as one or more of the following properties: low water absorption after water immersion, good bond to dry/damp concrete, good bond to HDPE substrates, good bond after water immersion, fast low-temperature curing, and low plasticizer migration.

Further example embodiments include methods for waterproofing using the above compositions and/or pastes, as well as waterproofing membranes, air barriers, and buildings comprising the compositions. These and other important objects, advantages, and features of the invention will become clear as this disclosure proceeds.

The invention accordingly comprises features of construction, combination of elements, and arrangement of parts that will be further exemplified in the following

### DETAILED DESCRIPTION OF EXEMPLARY EMBODIMENTS

In the following detailed description of the preferred embodiments, reference is made to the accompanying drawings, which form a part thereof, and within which are shown by way of illustration specific embodiments by which the invention may be practiced. It is to be understood that other embodiments may be utilized, and structural changes may be made without departing from the scope of the invention.

As used in this specification and the appended claims, the singular forms “a”, “an”, and “the” include plural referents unless the content clearly dictates otherwise. As used in this specification and the appended claims, the term “or” is generally employed in its sense including “and/or” unless the context clearly dictates otherwise.

As used herein, “about” means approximately or nearly and in the context of a numerical value or range set forth means ±15% of the numerical. In exemplary embodiments, the term “about” can include traditional rounding according to significant figures of the numerical value. In addition, the phrase “about ‘x’ to ‘y’” includes “about ‘x’ to about ‘y’”.

The term “slump” refers to sagging resistance of exemplary compositions of the present invention. This can be measured according to ASTM D 2202-00 (2019), which is a standard test method for determining slump of sealant compounds. A test flow jig, which resembles a standing plank having a 30 mm diameter round hole, with 10 mm depth (or thickness), allows sealant compound to be packed into and formed as a disk within the round hole (30 mm×10 mm). One first major face of the disk is defined by a plunger wall; the opposite major face of the disk can formed by using a straight edge, spatula, or blade to level off the compound placed into the hole. The plunger is used to push the shaped disk out of the hole, so that its first major face (formed against the plunger) is now flush with the outer surface of the jig and the disk can begin to flow down the vertical face of the jig. A reading can be taken of the maximum point of flow (downwards) of the compound in millimeters (mm) after ten minutes. A low slump value (mm) signifies that the sealant compound has a desirable resistance to slump (resists tendency to run downward) when applied to vertical wall. An example slump of between 0 and 20 mm includes a measurement of “essentially zero” where the slump (or vertical sag drop after 10 minutes) is so small that it might not be discernible or easily discernible by the unaided human eye.

The present inventors note that any range of numbers recited in the specification or claims, such as that representing a particular set of properties, units of measure, conditions, physical states or percentages, is intended to literally incorporate expressly herein by reference or otherwise, any number falling within such range, including any subset of numbers within any range so recited. For example, whenever a numerical range with a lower limit, RL, and an upper limit RU, is disclosed, any number R falling within the range is specifically disclosed. In particular, the following numbers R within the range are specifically disclosed: R=RL+k (RU−RL), where k is a variable ranging from 1% to 100% with a 1% increment, e.g., k is 1%, 2%, 3%, 4%, 5% . . . . 50%, 51%, 52% . . . 95%, 96%, 97%, 98%, 99%, or 100%. Moreover, any numerical range represented by any two values of R, as calculated above, is also specifically disclosed.

Exemplary embodiments of the invention are illustrated hereinbelow, along with example aspects of the embodiments. All parts and percentages of components within the compositions of the invention are understood to be based on total weight of the composition.

In a first example embodiment, the invention provides a non-aqueous, moisture-cured waterproofing paste composition, comprising:

a first silyl-terminated reactive polymer resin;

a second silyl-terminated reactive polymer resin, wherein the first silyl-terminated reactive polymer resin has a different chemical structure from the second silyl-terminated reactive polymer resin; and

a plurality of adhesion promoters, each including a functional silane, wherein a first adhesion promoter of the plurality of adhesion promoters comprises a hydrophobic diaminofunctional silane,

wherein the composition, upon curing, has a water absorption of about 15% or less after about 40 days of water immersion.

In a second example embodiment, which may be based on the first example embodiment, the non-aqueous moisture-cured waterproofing paste composition has preferably a slump between 0 and 20 mm prior to curing, more preferably a slump between 0 and 10 mm prior to curing; and most preferably a slump between 0 and 5 mm prior to curing, the slump being determined in accordance with ASTM D 2202-00 (2019).

In a third example embodiment, which may be based on any of the first through second example embodiments, the invention provides a moisture-cured waterproofing paste composition wherein the first silyl-terminated polymer resin comprises a dimethoxy silyl type, modified-silicone polyether polymer in an amount of about 2-40% by weight of the composition.

In a fourth example embodiment, which may be based on any of the first through third example embodiments above, the invention provides a moisture-cured waterproofing paste composition, wherein the second silyl-terminated polymer resin is a reactive silane terminated polyether polymer in an amount of about 2-40% by weight of the composition, wherein the reactive silane terminated polyether polymer is characterized by structural proximity of a nitrogen atom to a silicon atom in the dimethoxy(methyl)silyl-methylcarbamate group.

In a fifth example embodiment, which may be based on any of the first through fourth example embodiments above, the invention provides a moisture-cured waterproofing paste composition, wherein the plurality of adhesion promoters is present in an amount above 0% and below about 5% by weight of the composition.

In a sixth example embodiment, which may be based on any of the first through fifth example embodiments above, the invention provides a moisture-cured waterproofing paste composition, wherein the plurality of adhesion promoters comprises: a second adhesion promoter comprising a monomeric alkylfunctional silane, and a third adhesion promoter comprising a bifunctional organosilane.

In a seventh example embodiment, which may be based on any of the first through sixth example embodiments above, the invention provides a moisture-cured waterproofing paste composition, wherein the monomeric alkylfunctional silane comprises octyltrimethoxysilane.

In an eighth example embodiment, which may be based on any of the first through seventh example embodiments above, the invention provides a moisture-cured waterproofing paste composition, wherein the bifunctional organosilane comprises 3-glycidyloxypropyltrimethoxysilane having a reactive organic epoxide group and a hydrolysable inorganic methoxysilane group.

In a ninth example embodiment, which may be based on any of the first through eighth example embodiments above, the invention provides a moisture-cured waterproofing paste composition further comprising a plasticizer comprising polypropylene glycol.

In a tenth example embodiment, which may be based on any of the first through ninth example embodiments above, the invention provides a moisture-cured waterproofing paste composition further comprising fillers chosen from ground calcium carbonate, high-purity silica, or a combination thereof.

In an eleventh example embodiment, which may be based on any of the first through tenth example embodiments above, the invention provides a moisture-cured waterproofing paste composition further comprising additives chosen from inhibitors, pigments, anti-settlement aids, rheology modifiers (e.g., amide wax rheology modifiers), light stabilizers (e.g., HALS), UV absorbers, degassers, antistatic agents, antioxidants, moisture scavengers, accelerants, stabilizers, fire retardants, pH adjusters, reinforcing agents, thickening or thinning agents, elastic compounds, chain transfer agents, radiation absorbing or reflecting compounds, or a combination thereof.

In a twelfth example embodiment, which may be based on any of the first through eleventh example embodiments above, the invention provides a moisture-cured waterproofing paste composition further comprises a catalyst. Such catalyst is used for accelerating curing of the composition when exposed to moisture in the air. A preferred catalyst is dioctyltin dineodecanoate.

In a thirteenth example embodiment, which may be based on any of the first through twelfth example embodiments above, the invention provides a moisture-cured waterproofing paste composition having the following properties: peel adhesion to dry concrete at 23° C. between about 0.6 N/mm and about 2.0 N/mm, and peel adhesion to damp concrete at 23° C. between about 0.6 N/mm and about 2.0 N/mm. Peel adhesion can be determined in accordance with ASTM D903-98 (2017) (modified).

In a fourteenth example embodiment, which may be based on any of the first through thirteenth example embodiments above, the invention provides a moisture-cured waterproofing paste composition having a cure time at 5° C. under about 24 hours. For example, these cure time properties may be obtained at 75% relative humidity at atmospheric pressure.

In a fifteenth example embodiment, which may be based on any of the first through fourteenth example embodiments above, the invention provides a moisture-cured waterproofing paste composition having no observable plasticizer migration upon curing within four (4) weeks of contact and stored at +60° C.

In a sixteenth example embodiment, which may be based on any of the first through fifteenth example embodiments above, the invention provides a moisture-cured waterproofing paste composition wherein the water absorption of the composition, upon curing, is about 10% or less after about 40 days of water immersion.

In a seventeenth example embodiment, which may be based on any of the first through sixteenth example embodiments above, the invention provides a moisture-cured waterproofing paste composition, wherein the water absorption of the composition, upon curing, is about 5% or less after about 40 days of water immersion.

In an eighteenth example embodiment, which may be based on any of the first through seventeenth example embodiments above, the invention provides a moisture-cured waterproofing paste composition, wherein the composition has the following properties: peel adhesion to dry concrete at 23° C. after about 28-day water immersion between about 0.2 N/mm and about 2.0 N/mm, and peel adhesion to damp concrete at 23° C. after about 28-day water immersion between about 0.2 N/mm and about 2.0 N/mm. The peel adhesion may be determined according to ASTM D903-98 (2017)(modified).

In a nineteenth example embodiment, the invention provides a waterproofing paste, comprising at least one silyl-terminated polymer resin and a plurality of adhesion promoters, wherein the paste has the following properties:); a cure time at 5° C. under about 24 hours; peel adhesion to damp concrete at 23° C. between about 0.6 N/mm and about 2.0 N/mm, the peel adhesion being determined in accordance with ASTM D 903-98 (2017)(modified); and a water absorption of about 30% or less after about 40 days of water immersion.

In a twentieth example embodiment, which may be based on the nineteenth example embodiment, the waterproofing paste has preferably a slump between 0 and 20 mm prior to curing, more preferably a slump between 0 and 10 mm prior to curing; and most preferably a slump between 0 and 5 mm prior to curing, the slump being determined in accordance with ASTM D 2202-00 (2019).

In a twenty-first example embodiment, which may be based on any of the nineteenth through twentieth example embodiments above, the invention provides a waterproofing paste wherein the paste has peel adhesion to dry concrete at 23° C. between about 0.6 N/mm and about 2.0 N/mm (ASTM D 903-98 (2017) (modified)).

In a twenty-second example embodiment, which may be based on any of the nineteenth through twenty-first example embodiments above, the invention provides a waterproofing paste, wherein the paste has peel adhesion to a corona treated HDPE substrate at 23° C. between about 0.6 N/mm and about 2.0 N/mm (ASTM D1876 08 (2015)).

In a twenty-third example embodiment, which may be based on any of the nineteenth through twenty-second example embodiments above, the invention provides a waterproofing paste, wherein the paste has peel adhesion to a corona treated HDPE substrate at 23° C. after about 28-day water immersion between about 0.2 N/mm and about 2.0 N/mm (ASTM D 1876 08 (2015)).

In a twenty-fourth example embodiment, which may be based on any of the nineteenth through twenty-third example embodiments above, the invention provides a waterproofing paste, wherein the paste has peel adhesion to a corona treated HDPE substrate at 23° C. after about 3-month water immersion between about 0.2 N/mm and about 2.0 N/mm (ASTM D 1876 08 (2015)).

In a twenty-fifth example embodiment, which may be based on any of the nineteenth through twenty-fourth example embodiments above, the invention provides a waterproofing paste, wherein the paste has the following properties: peel adhesion to dry concrete at 23° C. after about 28-day water immersion between about 0.2 N/mm and about 2.0 N/mm, and peel adhesion to damp concrete at 23° C. after about 28-day water immersion between about 0.2 N/mm and about 2.0 N/mm (ASTM D 903-98 (2017) (modified)).

In a twenty-sixth example embodiment, which may be based on any of the nineteenth through twenty-fifth example embodiments above, the invention provides a waterproofing paste, wherein the paste has a water absorption, upon curing, of about 15% or less after about 40 days of water immersion.

In a twenty-seventh example embodiment, which may be based on any of the nineteenth through twenty-sixth example embodiments above, the invention provides a waterproofing paste, wherein the water absorption of the paste, upon curing, is about 10% or less after about 40 days of water immersion.

In a twenty-eighth example embodiment, which may be based on any of the nineteenth through twenty-seventh example embodiments above, the invention provides a waterproofing paste, wherein the water absorption of the paste, upon curing, is about 5% or less after about 40 days of water immersion.

In a twenty-ninth example embodiment, which may be based on any of the nineteenth through twenty-eighth example embodiments above, the invention provides a waterproofing paste, wherein each of the plurality of adhesion promoters includes a functional silane.

In a thirtieth example embodiment, which may be based on any of the nineteenth through twenty-ninth example embodiments above, the invention provides a waterproofing paste, wherein the at least one silyl-terminated polymer resin comprises at least a pair of silane terminated polyether polymers.

In a thirty-first example embodiment, which may be based on any of the nineteenth through thirtieth example embodiments above, the invention provides a waterproofing paste further comprising a plasticizer comprising polypropylene glycol.

In a thirty-second example embodiment, which may be based on any of the nineteenth through thirtieth-first example embodiments above, the invention provides a waterproofing paste, wherein the plurality of adhesion promoters comprises: a first adhesion promoter comprising a hydrophobic diaminofunctional silane; a second adhesion promoter comprising a monomeric alkylfunctional silane; and a third adhesion promoter comprising a bifunctional organosilane.

In a thirty-third example embodiment, which may be based on any of the nineteenth through thirty-second example embodiments above, the invention provides a waterproofing paste further comprising fillers chosen from ground calcium carbonate, high-purity silica, or a combination thereof.

In a thirty-fourth example embodiment, which may be based on any of the nineteenth through thirty-third example embodiments above, the invention provides a waterproofing paste further comprising additives chosen from inhibitors, pigments, anti-settlement aids, rheology modifiers (e.g., amide wax rheology modifiers), light stabilizers (e.g., HALS), UV absorbers, degassers, antistatic agents, antioxidants, moisture scavengers, accelerants, stabilizers, fire retardants, pH adjusters, reinforcing agents, thickening or thinning agents, elastic compounds, chain transfer agents, radiation absorbing or reflecting compounds, or a combination thereof.

In a thirty-fifth example embodiment, which may be based on any of the nineteenth through thirty-fourth example embodiments above, the invention provides a waterproofing paste further comprising a catalyst.

In a thirty-sixth example embodiment, the invention provides a method of waterproofing a substrate, comprising applying the moisture-cured waterproofing paste composition of any of the first through thirty-fifth example embodiments above to the substrate and allowing the composition to cure on the substrate.

In a thirty-seventh example embodiment, the invention provides a waterproofing membrane, wherein the membrane comprises: a carrier sheet, and, generally coextensive with a portion or with the entirety of the carrier sheet, the moisture-cured waterproofing composition of any of the first through thirty-sixth example embodiments described above. In an example aspect of this example embodiment, the carrier sheet may be formed from a polymer film (e.g., polyethylene, polypropylene, or mixture thereof), a fabric (e.g., woven, non-woven, spunbonded), and may optionally include a release-able protective cover sheet). Exemplary layers of compositions made in accordance with the present invention may also further be protected by elastomeric coatings, particle coatings, removable release sheets, or combinations thereof, as may be known in the pre-applied waterproofing art.

In a thirty-eighth example embodiment, the invention provides an air barrier, comprising the composition of any of the first through thirty-seventh example embodiments above.

In a thirty-ninth example embodiment, the invention provides a waterproofing system comprising: pre-formed sheet-like rollable waterproofing membranes comprising a carrier layer made of a polymer carrier film (e.g., high density polyethylene, propylene, or mixture thereof) and an adhesive layer (which may be based on conventional waterproofing pressure-sensitive adhesives or a sealant composition based on any of the first through thirty-eighth example embodiments above); and a waterproofing coating composition based on any of the first through thirty-eighth example embodiments above. For example, the rollable waterproofing membranes can be based on commercially available waterproofing membranes sold for “blind-side” waterproofing applications (e.g., PREPRUFE® or PV® 100 membranes) sold by GCP Applied Technologies (a Delaware corporation having offices within Massachusetts as well as various international offices). Exemplary compositions of the present invention are contemplated by the presence inventors to be effective for bonding with such membranes, whether the front or back sides of sheet-form membranes, in creating a monolithic waterproofing barrier on a building substrate, and/or bonding with formworks against which concrete is cast or sprayed against the adhesive-side of the sheet-form and/or liquid-applied membranes to bond against the membranes. For example, the back sides of conventional sheet-like membranes are typically made of polyolefin film.

As can be seen above, certain embodiments of the current composition provide several beneficial properties that result from the composition and material itself, for example including good curing at 5° C., good adhesion to dry and damp concrete, good bond even after 7 days water immersion, low water absorption when immersed in water as free film, and/or good adhesion to corona treated high density polyethylene (HDPE).

Further example embodiments and aspects of the invention are described hereinafter which have potential application to the specifically enumerated exemplary embodiments above.

In other example embodiments, the current invention is a waterproofing composition have a paste/paste-like consistency, the composition comprising at least one silyl-terminated polymer resin (preferably an MS polymer and an STPE polymer) and a plurality of adhesion promoters (preferably at least three silane-functional adhesion promoters), wherein the composition, prior to curing, has preferably a slump between 0 and 20 mm, more preferably a slump between 0 and 10 mm, and most preferably a slump between 0 and 5 mm, the slump being determined in accordance with ASTM D 2202-00 (2019); and, upon curing, has a water absorption of about 15% or less after about 40 days of water immersion. As needed, exemplary compositions may further include plasticizers, catalysts, additives, and fillers. Certain embodiments of the composition can have different applications, from use as a detailing waterproofing membrane, to use as a full air barrier, depending on the needs of the build. Other beneficial properties are also contemplated herein (e.g., bond to dry/damp concrete, bond to HDPE substrates, bond after water immersion, fast low-temperature curing, low plasticizer migration, etc.). These aspects of various embodiments of the current invention will become clearer as this specification continues.

Within the context of the present disclosure, the term “silyl-terminated polymer resin” refers to a synthetic sealant compound terminating with a silyl group. Silyl-terminated polymers are a class of polymers typically having many repetitive units in a middle and long section thereof. An end group of the long middle section, also referred to as a terminating group, is a silyl type molecule. Commercially available examples of such polymers are silyl/modified silicone polymers comprising a reactive polymer with polypropyleneoxide main chain and dimethoxysilyl end-groups. Its molecular weight is directly related to the amount of polypropyleneoxide units. Dimethoxysilyl, trimethoxysilyl, diethoxysilyl, and/or triethoxysilyl terminated polyethers may be used. Further examples include a polyether polymer with isocyanate termination with aminosilanes and a polyether polymer with amino termination and/or hydroxyl termination with isocyanate-terminated silanes. Reactions of the reactive groups with other materials in the composition is also possible to create cross-links. Examples of silyl-terminated polymer resins include, but are not limited to, linear polymers such as polypropyleneoxide main chains with different molecular weights (e.g., KANEKA™ S203H, S303H, SAX350, SAX725), branched polymers such as trimethoxysilyl propyl carbamate-terminated polyethers, such as, for example, KANEKA™ SAX400; GENIOSIL™ STPE35, GENIOSIL® STP E10 or GENIOSIL™ STP E30, or derived from the polyether polymer backbone coupled with the methyl dimethoxy silane functional groups (e.g. SAX750) or with lateral crosslinking groups (e.g. TEGOPAC® Bond 160 from Evonik) and combinations thereof. The present inventors contemplate that alternative resins may be used. For example, in addition to or in combination with KANEKA™ SAX400, it is believed that linear as well as branched polypropyleneoxide polymer and different molecular weights may be used, e.g., KANEKA™ SAX 203H, SAX 303H, SAX 350, and SAX 725. The amount of the silyl-terminated polymer resin utilized can be about 5-40% by weight of the composition, preferably about 10-25% by weight of the composition, and, more preferably, about 15-25% by weight of the composition, or in a range between any two of these values.

Within the context of the present disclosure, the term “adhesion promoter” refers to a functional component having one or more reactive groups that create a molecular bridge between the substrate and other compounds, such as the resins within the paste composition taught herein. Each adhesion promoters used in the current composition should have a functional silane or functional equivalent. Examples of adhesion promoters include, but are not limited to, gamma-aminopropyltrimethoxysilane, N-(beta-aminoethyl)-gamma-aminopropyltrimethoxysilane, bis(gamma-trimethoxysilylpropylamine), gamma-ureidopropyltrimethoxysilane, 4-amino-3,3-dimethylbutyltrimethoxysilane, 4-amino-3,3-dimethylbutylmethyldimethoxysilane, n-ethyl-gamma-aminoisobutyltrimethoxysilane, aminoalkyl oligomeric silane (composed of partially co-hydrolyzed., propyltrimethoxysilane, beta (3,4-epoxycyclohexyl)ethyltriethoxysilane, beta (3,4-epoxycyclohexyl)ethyltrimethoxysilane, 3-glycidoxypropyltrimethoxysilane, gamma-glycidoxypropyltriethoxysilane, gamma-glycidoxypropyl trimethoxysilane, gamma-glycidoxypropylmethyldiethoxysilane, vinyl triethoxysilane, vinyl triisopropoxysilane, vinyl methyldimethoxysilane, vinyl organofunctional silanes, gamma-mercaptopropyltrimethoxysilane, gamma-mercaptopropyltriethoxysilane, 3-octanoylthio-1-propyltriethoxysilane, oligomerized gamma-mercaptopropyltrimethoxysilane, bis-(3-[triethoxysilyl]propyl)disulfide, bis-(3-[triethoxysilyl]propyl) polysulfide, gamma-methacryloxypropyltrimethoxysilane, gamma-methacryloxypropyltriethoxysilane, gamma-methacrylamidopropyltrimethoxysilane, gamma-methacryloxypropyltriisopropoxysilane, octyltrimethoxysilane, octyltriethoxysilane, propyltriethoxysilane, methyl triethoxysilane, methyl trimethoxysilane, oligomeric diaminosilane, oligomeric aminoalkylalkoxy silane, oligomer aminoalkoxysilane, aminofunctional oligosiloxane, methacryl endcapped silicone, epoxy silicone, linear aminosilicone polyether copolymer, aminoethylaminopropyl cyclic oligosiloxane, phenylethyl modified siloxane, octyl functional trisiloxane, 4-acetoxy-3-methoxyphenylpropyltrimethoxy silane, tris[3-(trimethoxysilylpropyl)]isocyanurate, poly(ethyleneoxide)trimethoxysilane, hexadecyltrimethoxy silane, bis(triethoxysilyl)ethane and combinations thereof. In a preferred embodiment, the adhesion promoters comprise a combination of oligomeric diaminosilane, 3-glycidoxypropyltrimethoxysilane, and/or octyltrimethoxysilane. The amount of the adhesion promoter utilized can be about 0.25-2.5% by weight of the composition, preferably about 0.3-2.0% by weight of the composition, and even more preferably about 0.35-1.5% by weight of the composition, or in a range between any two of these values.

Within the context of the present disclosure, the term “plasticizer” refers to materials that can be added to the composition to decrease viscosity of the composition and/or improve dispersion of fillers or other additives within the composition. Examples of plasticizers that are contemplated to be used herein include, but are not limited to, esters such as phthalates (e.g., dioctyl phthalates, diisononyl phthalates, diisodecyl phthalates), adipates (e.g., dioctyl adipates), benzoates, azelates, sebacates, polyols with different molecular weights (e.g., polyoxyalkylenopolyols, polyesterpolyols), polypropylene glycol, glycol esters, glycol ether ester, organic phosphoric/sulfonic esters, polybutenes, polystyrenes, polybutadienes, polychloroprenes, polyisoprenes, parafins, fatty acid methyl/ethyl esters derived from natural fats/oil or castor oils, reactive diluents, and combinations thereof. In a preferred embodiment, polypropylene glycol is used as the plasticizer. The amount of plasticizer within the composition can be between about 5% and about 30% by weight of the composition, more preferably between about 10% and 25% by weight of the composition.

Within the context of the present disclosure, the term “plasticizer migration” refers to the movement or transfer of plasticizer from a waterproofing composition into a substrate to which the membrane is adhered or into a surface with which the membrane is in contact. The consequence of plasticizer migration is that the waterproofing composition can become harder and/or more brittle, and the surface or substrate that receives the plasticizer can swell, becoming softer and/or tackier. This can result in a drop in adhesion and waterproofing properties. As such, it is generally desirable to minimize or eliminate plasticizer migration. Amount or levels of plasticizer migration may be determined by methods known in the art. Within the context of the present disclosure, plasticizer migration measurements are done according to ASTM D2199-03 (2013) standards (modified to estimate migration with different substrates), unless otherwise stated. Preferably, the composition taught by the present disclosure, results in no observable plasticizer migration into a substrate in contact with the composition, within one (1) week of contact and stored at +60° C., more preferably within two (2) weeks of contact and stored at +60° C., and even more preferably within four (4) weeks of contact and stored at +60° C.

Within the context of the present disclosure, the term “catalyst” refers to a compound or substance that catalyzes or speeds up curing or polymerization upon mixing with the remainder of the composition. Exemplary catalysts include, but are not limited to, metal catalysts, such as organo compounds of zirconium, titanium, alminium or tin, having alkoxy, aminoalkoxy, dialkylphopahte, carboxyl, sulfonate, 1,3-diketonate, 1.3-ketoestreate and dialkylpyrophosphate groups. Examples of metal catalysts include, but are not limited to, dialyltin oxides, dialkultin oxides, dibutyltin dichlorides, dialkyltin dochlorides, dibutyltin diacetates, dioctyltin dicetates, dibutyltin dilaurates, dibutyltin diacetylacetonates, dioctyltin oxides, dioctyltin dichlorides, dioctyltin diketanoates, dioctyltin dilaurates and dioctyltin diacetylacetonates. In a preferred embodiment, the catalyst comprises dioctyltin diketanoate. The amount of catalyst utilized can be about 0-5% by weight of the composition, preferably about 0.25-3% by weight of the composition, and even more preferably about 0.5-1.5% by weight of the composition, or in a range between any two of these values. In contrast to accelerators, an inhibitor may optionally be added to provide storage stability or delay curing of the reaction mixture.

As indicated previously, additives may be added at certain points during the foregoing formulating process. Within the context of the present disclosure, the term “additive” refers to optional materials that can be added to the bond coat composition. Additives can be added to alter or improve desirable properties in the waterproofing composition, or to counteract undesirable properties therein. Examples of additives includes, but are not limited to, inhibitors, pigments, anti-settlement aids, rheology modifiers (e.g., amide wax rheology modifiers), light stabilizers (e.g., HALS), UV absorbers, degassers, antistatic agents, antioxidants, moisture scavengers, accelerants, stabilizers, fire retardants, pH adjusters, reinforcing agents, thickening or thinning agents, elastic compounds, chain transfer agents, radiation absorbing or reflecting compounds, and other additives known in the art. The amount of additive utilized can be about 0-50% by weight of the composition in which the additive is present.

Fillers may also be added to the composition. In a preferred embodiment, the filler comprises ground calcium carbonate, high-purity silica, and combinations thereof. The amount of filler utilized can be about 0-50% by weight of the composition.

Within the context of the present disclosure, the term “slump” refers to a measure of fluidity or consistency of a material before it sets/cures/polymerizes. A lower slump corresponds to lower fluidity (e.g., paste or nearly solid), whereas a higher slump corresponds to higher fluidity (e.g., liquid). Slump is typically recorded in millimeters (mm). The slump of a material, such as the current paste-like composition, may be determined by methods known in the art. Within the context of the present disclosure, slump measurements are acquired according to ASTM D2202-00 (2019), unless otherwise stated. Specifically, slump was tested using a flow test jig, constructed in accordance with the standard. The clean jig was placed on a level table, and a plunger was depressed to the limit of its travel. The tested material was placed into the jig cavity. The plunger was set up in correct position, and the jig was placed immediately into a vertical position for about 10 minutes. At the end of the 10-minute period, readings were taken of the maximum point of flow of the material (down the face of the jig). Preferably, the composition taught by the present disclosure, prior to curing, has a slump between 0 mm and about 20 mm, more preferably between about 0 mm and about 10 mm, and even more preferably between about 0 mm and about 5 mm, or in a range between any two of these values. It is contemplated that these slump measurements result in a thixotropic paste that can be packaged in any suitable container, for example cartridges, sausages, or pails.

Within the context of the present disclosure, the term “peel adhesion” refers to a measure of bond strength between two distinct materials, such as between a waterproofing membrane and concrete, where the cured membrane resists static forces that cause one or both materials to de-bond. Peel adhesion is typically recorded as an average force per linear width, e.g., as measured in inches (pounds per linear inch, lbs/in or PLI) or Newtons per millimeter (N/mm), and may be determined by methods known in the art. Unless otherwise indicated, peel adhesion measurements of the inventive composition are done according to ASTM D903-98 (2017) (modified whereby 90° peel angle and 2″/min rate of travel of the grip with load cell 500 N) is performed in the following way). A concrete block is attached to the frame of a tensile testing machine (e.g., ZWICK® Z020). The loose end of a tested specimen strip is gripped by the jaw of the tensile testing machine. During the test, the tensile testing machine pulls off the tested strip for the distance of about 20 cm. The speed of machine movement is about 2 inches per minute. During the machine movement, any material breaks and the average force of break is noted. Four measurements are taken for each test. Peel adhesion testing is carried out in laboratory conditions (e.g., 20° C.-24° C., 30-50% relative humidity), unless otherwise specified. In adhesion testing after water immersion, tests were conducted at room temperature just after removing specimens from water. Three types of failure modes were considered: adhesive failure (rupture of an adhesive bond, such that the separation appears to be at the adhesive-adherend interface), cohesive failure (rupture of adhesive bond, such that the separation appears to be within the adhesive), and failure of the sample to adhere at all (when sample falls from the substrate).

Within the context of the present disclosure, the term “damp concrete” refers to a concrete block kept for at least 24 hours in water, then taken out and all excess of water and standing water is removed, allowing the surface to become almost dry to provide a saturated surface dry conditions before installation of product.

Preferably, peel adhesion between the composition taught herein and damp/dry concrete is between about 0.5 N/mm and about 2.0 N/mm, more preferably between about 1.0 N/mm and 1.5 N/mm, or in a range between any two of these values. Furthermore, peel adhesion between the composition taught herein and concrete after water immersion is between about 0.5 N/mm and about 2.0 N/mm, more preferably between about 1.0 N/mm and 1.5 N/mm, or in a range between any two of these values (ASTM D 903-98 (2017) (modified)).

To create the tested specimen strips including concrete and certain embodiments of the current composition, the following procedure can be used. Concrete blocks are formed of construction grade concrete cast into polyethylene molds having a dimension of about 18×4×28 cm and left for curing for a minimum of about 7 days. The concrete mix was designed in accordance of EN 1504, C30/37, F3 from EN 206:

TABLE 1
Concrete mix design

| | Content, % w/w |
|---|---|
| Aggregates 0-2 | 27.2 |
| Aggregates 2-8 | 23.3 |
| Aggregates 8-16 | 27.2 |
| Cement CEM I 42, 5R | 24.4 |
| Water | 7.4 |
| Sum | 100 |

When testing adhesion to dry or damp concrete, the bottom (smooth) side of the block is used as the substrate for the liquid membrane taught herein. No special surface preparation is required. To dampen concrete, the at least 7-day-old concrete block is immersed in water for at least 24 hours, during which time the concrete block is fully saturated with water. Just before membrane application, the concrete block is taken out from the water, and its surface is wiped with a paper cloth.

On the edge of the concrete block, about 18 cm of separation tape is applied to provide no adhesion at the very edge of the block. This allows the jaws of the tensile testing machine to grip the sample. Two layers of an embodiment of the current paste composition, each about 1 mm thick, are applied. Between the two layers, a fabric mesh is immersed. The mesh is used to reinforce the material just for the adhesion test. The samples are left for one week to allow full curing of the material. When testing initial adhesion, after the curing period, the material is cut into four strips having dimensions of about 50×8×200 mm. These strips can be used as described above to measure peel adhesion.

To test adhesion after water immersion, concrete blocks prepared with the above-described adhesion tape are fully immersed in water container for the desired period of time (here 7, 28 and 90 days). Specifically, a plastic container is filled in with tap water. In one container, six concrete blocks might be stored side-by-side. After a predetermined period of time, the concrete blocks are removed from water, and the surface is wiped with paper cloth. The material is cut into four strips having dimensions of about 50×8×200 mm. These strips can be used as described above to measure peel adhesion.

Peel adhesion measurements of compositions of the present invention applied to a flexible substrate, such as an HDPE substrate, are referred to herein as “T-peel adhesion” and done according to ASTM D1876-08 (2015) unless otherwise stated. The HDPE substrates are modified by corona treatment by plasma discharge, and the exemplary strips are prepared having dimensions of about 300-mm width and 1000-mm length. One end of each HDPE strip is secured with tape to provide a tab for grips. About two (2) mm of the current composition are applied on the top surface of the HDPE strip. The material is allowed to cure for seven (7) days at lab conditions. Four 75-mm wide and 250-mm long samples are cut in machine direction. Each sample is installed in the tensile testing machine, and T-peel adhesion is tested in the test frame at a crosshead speed of 50 mm/min. Similar to before, three types of failure modes were considered: adhesive failure (rupture of an adhesive bond, such that the separation appears to be at the adhesive-adherend interface), cohesive failure (rupture of adhesive bond, such that the separation appears to be within the adhesive), and failure of the sample to adhere at all (when samples fall from the substrate). Preferably, T-peel adhesion of the composition of the present invention with respect to a flexible substrate is between about 0.5 N/mm and about 2.0 N/mm, more preferably between about 1.0 N/mm and 1.5 N/mm, or in a range between any two of these values.

It is believed that the present invention provides compositions that have relatively similar adhesion values for various concrete surface states: e.g., when applied on damp/dry concrete, concrete after water immersion, and flexible substrates. It might be typically expected for adhesive compositions might have highest adhesion values with respect to damp/dry concrete substrates, then next highest adhesion values with respect to flexible substrates, and lowest adhesion values with respect to concrete after water immersion. However, for compositions of the present invention, the present inventors were surprised to find that the compositions of the present invention had similar adhesion properties. With regard to damp/dry concrete, concrete after water immersion, and flexible substrates, the adhesion values were preferably within about 20% of each other; more preferably, they were within about 10% of each other; and, most preferably, the adhesion values were about 5% of each other. In other words, the current composition was able to bond to multiple types of substrates similarly.

Within the context of the present disclosure, the term “cure time” refers to the amount of time needed for a liquid or paste material to form a skin or membrane at a preselected temperature. Cure time is typically recorded as a unit of time (e.g., hours, minutes) and may be determined by methods known in the art. Within the context of the present disclosure, unless otherwise stated, curing of the current composition is acquired according to the following methodology. A sample cartridge including the current paste composition and a substrate (e.g., metal panel) is stored at a desired temperature at least about 12 hours before application and testing. The sample is then prepared by applying an approximately 2 mm thick and approximately 50 mm long strip of the current paste composition on the substrate. The specimen is stored at a preselected temperature (e.g., +5° C.), and a wooden spatula can be used to check if the material has started to cure. Cure time of the material is checked in time intervals (e.g., after about 1 hour, 6 hours, 8 hours, 24 hours, etc.). When the material has reached skin formation and/or full cure at full thickness (i.e., the material does not adhere to or stay on the spatula), the time is recorded. As will be seen, the current composition has good cure time at low temperatures, such as approximately +5° C. In other words, the preselected temperature at which the specimen is stored can be +5° C., while still maintaining an efficient cure time. Preferably, the composition taught by the present disclosure has a cure time at +5° C. between about 2 hours and about 24 hours, more preferably between about 3 hours and about 18 hours, and even more preferably between about 4 hours and about 12 hours, or in a range between any two of these values.

Within the context of the present disclosure, the term “water absorption” refers to a measure of the amount of water absorbed by a sample material upon immersion within that water. As discussed herein, low water absorption is preferred in order to maintain the properties of the material/membrane. The water absorption of a material, such as the current paste-like composition, may be determined by methods known in the art. Within the context of the present disclosure, water absorption measurements are acquired according to the standard testing method described in ASTM D 570 (2018), unless otherwise stated. Specifically, test specimens were cut from free film samples of the cured membrane, which includes the current composition applied onto a substrate dried for about 24 hours at about 50° C., and allowed to cool. Initial mass and thickness of the cured membrane were recorded. For 24-hour water immersion, the conditioned specimens were placed in a container of distillated water maintained at lab temperature (20°-24° C.) and were fully immersed. At the end of about 24 hours, the specimens were removed from the water one at a time. All surface water was wiped off with dry cloth, and the specimens were immediately weighed to nearest 0.001 g. Longer term water immersion follows a similar procedure, with the test specimens immersed in water for about 40 days. In both cases, water absorption is calculated using the percentage of mass gained after immersion. Preferably, the composition taught by the present disclosure, when fully cured, has a water absorption (both after about 24 hours and after about 40 days) of about 30% or less, about 25% or less, about 20% or less, about 15% or less, about 10% or less, about 7% or less, or about 5% or less. It is contemplated that the composition taught by the present disclosure, when fully cured, can even absorb no water at all, i.e., a water absorption of 0%. As will be seen, STPE polymer-based composition tend to have very high water absorption levels, which is detrimental to the function of the composition.

### APPLICATIONS

The paste composition taught herein can be used in a variety of ways when acting as a barrier to water, air, and/or vapor. When functioning as a waterproofing membrane, it is typically applied as a detailing membrane due in part to its paste consistency. Detailing compounds are designed to be used where liquid applied waterproofing is needed to as part of a system designed to provide the overall system with watertight continuity. Detailing compounds are typically used at overlaps, seams, pile head terminations, pipe and rod penetrations, membrane continuity through masonry, internal and external corners (fillet material), flashing material around drains, protrusions, curbs, parapets, or other high-risk areas for water penetration. As a detailing membrane, the composition has a paste consistency that can effectively conform to irregular profiles, as well as being resistant to water vapor and water pressure and being damage resistant and seamless. The composition can also function compatibly with other waterproofing membranes, such as PREPRUFE® brand membranes and BITUTHENE® brand membranes from GCP Applied Technologies Inc., Massachusetts USA.

In addition, the paste composition taught herein can be applied and used as an air barrier. Air barriers are systems of materials designed and constructed to control airflow between a conditioned space and an unconditioned space. The air barrier system is the primary air enclosure boundary that separates indoor (conditioned) air and outdoor (unconditioned) air. In multi-unit/townhouse/apartment construction, the air barrier system also separates the conditioned air from any given unit and adjacent units. Air barrier systems also typically define the location of the pressure boundary of the building enclosure. The composition can be applied in any suitable manner across larger surface areas (relative to the detailing membrane discussed above) to form an effective air barrier.

### EXAMPLES/EXPERIMENTS

While the invention is described herein using a limited number of embodiments, these specific embodiments are not intended to limit the scope of the invention as otherwise described and claimed herein. Modification and variations from the described embodiments exist. More specifically, the following examples are given as a specific illustration of embodiments of the claimed invention. It should be understood that the invention is not limited to the specific details set forth in the examples. All parts and percentages, as well as in the remainder of the specification, are by weight of the total bond coat composition, unless otherwise specified.

### Comparative Examples 1-7

Comparative waterproofing compositions/materials were tested (Comparative Examples 1-3) or formulated and tested (Comparative Examples 4-7) in accordance with the components listed in Table 2, where the compositions resulted in the properties listed in Table 4.

TABLE 2

| | Comp. | Comp. | Com. | Comp. | Comp. | Comp. | Comp. |
|---|---|---|---|---|---|---|---|
| | Ex. 1 | Ex. 2 | Ex. 3 | Ex. 4 | Ex. 5 | Ex. 6 | Ex. 7 |
| STPE Polymer (% w/w) | GCP MS | Kömmerling | Max | 43.97 | 29.06 | 24.86 | 29.64 |
| Plasticizer (% w/w) | Fixer | Körapop | Frank | 42.94 | 28.60 | 24.39 | 29.17 |
| Filler (ground calcium | | 225 | Cresco | | 28.63 | 39.32 | 29.20 |
| carbonate) (% w/w) | | | | | | | |
| Fumed silica | | | | 0.76 | 0.33 | 0.34 | 0.34 |
| Titanium dioxide | | | | | 4.76 | 4.89 | 4.86 |
| Mineral spirits | | | | 3.96 | 3.05 | 1.79 | 1.78 |
| Pigment (% w/w) | | | | 0.54 | 0.24 | 0.24 | 0.24 |
| Light stabilizer (HALS) | | | | 1.08 | 0.48 | 0.49 | 0.49 |
| (% w/w) | | | | | | | |
| UV Absorber (% w/w) | | | | 0.54 | 0.24 | 0.24 | 0.24 |
| Antioxidant (% w/w) | | | | 0.76 | 0.33 | 0.34 | 0.34 |
| Moisture scavenger | | | | 2.24 | 2.14 | 1.27 | 1.52 |
| Silane-functional | | | | 2.24 | 1.49 | 1.27 | 1.52 |
| adhesion promoter (n-2- | | | | | | | |
| aminoethyl-3- | | | | | | | |
| aminopropyl- | | | | | | | |
| trimethoxysilane) | | | | | | | |
| Catalyst | | | | 0.97 | 0.65 | 0.55 | 0.66 |

TABLE 3
Formulations of Comparative Examples 1-5.

| | Comp. | Comp. | Com. | Comp. | Comp. | Comp. | Comp. |
|---|---|---|---|---|---|---|---|
| | Ex. 1 | Ex. 2 | Ex. 3 | Ex. 4 | Ex. 5 | Ex. 6 | Ex. 7 |
| Plasticizer migration at | Migration | | | | | | |
| 60° C. | after 1 day | | | | | | |
| Peel adhesion to dry | 2.45 | 2.35 | 2.27 | | | | |
| concrete at 23° C. | (coh) | (coh) | (coh) | | | | |
| (N/mm) | | | | | | | |
| Peel adhesion to damp | 2.43 | 0.17 | 0.16 | | | | |
| concrete at 23° C. | (coh) | (adh) | (adh) | | | | |
| (N/mm) | | | | | | | |
| Peel adhesion to dry | 0 (after | | | | | | |
| concrete at 23° C. after | 7 days) | | | | | | |
| 28-day water immersion | | | | | | | |
| (N/mm) | | | | | | | |
| Peel adhesion to damp | 0 (after | | | | | | |
| concrete at 23° C. after | 7 days) | | | | | | |
| 28-day water immersion | | | | | | | |
| (N/mm) | | | | | | | |
| Water absorption after | 19% | 17% | | 200+% | 100+% | 100+% | 100+% |
| 40 days | | | | | | | |

### Examples 1-5

Exemplary waterproofing compositions having a paste or paste-like consistency were formulated in accordance with the components listed in Table 4, where the compositions resulted in the properties listed in Table 5. Each composition includes at least one MS/STPE polymer, at least one adhesion promoter, fillers, and additives. The compositions can be created using the following general methodology. MS/STPE polymer(s), plasticizers, fillers, stabilizers, and pigments are mixed and heated until uniform with water content measured. The moister scavenger is added, followed by the adhesion promoter(s) and catalysts.

TABLE 4
Formulations of Examples 1-5 (example
embodiments of the current invention).

| | Ex. 1 | Ex. 2 | Ex. 3 | Ex. 4 | Ex. 5 |
|---|---|---|---|---|---|
| MS Polymer (% w/w) | 10.00 | 10.00 | 19.9 | 19.9 | |
| STPE Polymer (% w/w) | 10.00 | 10.00 | | | 45 |
| Plasticizer (% w/w) | 15.00 | 15.00 | 14.9 | 14.9 | |
| Filler (ground calcium carbonate) | 38.25 | 39.00 | 40.00 | 39.8 | 37.3 |
| (% w/w) | | | | | |
| Filler (high-purity silica) (% w/w) | 20.00 | 20.00 | 19.9 | 19.9 | |
| Aluminum hydroxide | | | | | 11.00 |
| Pyrogenic silica | | | | | 1.50 |
| Pigment (% w/w) | 0.25 | | | | |
| Amide wax rheology modifier (% | 1.50 | 1.00 | 0.60 | 0.60 | 0.60 |
| w/w) | | | | | |
| Light stabilizer (HALS) (% w/w) | 0.35 | 0.35 | 0.30 | 0.30 | 2.00 |
| UV Absorber (% w/w) | 0.60 | 0.60 | 0.60 | 0.60 | |
| Antioxidant (% w/w) | 0.20 | 0.20 | 0.20 | 0.20 | |
| Moisture scavenger | 0.40 | 0.40 | 0.40 | 0.40 | 1.90 |
| Silane-functional adhesion | 0.65 | 0.65 | 0.60 | 0.60 | |
| promoter (oligomeric | | | | | |
| diaminosilane) | | | | | |
| Silane-functional adhesion | 0.40 | 0.40 | 0.40 | 0.40 | |
| promoter (3- | | | | | |
| glycidoxypropyltrimethoxysilane) | | | | | |
| Silane-functional adhesion | 1.40 | 1.40 | 1.40 | 1.40 | |
| promoter (octyltrimethoxysilane) | | | | | |
| Silane-functional adhesion | | | | | 0.70 |
| promoter (3- | | | | | |
| aminopropyltrimethoxysilane) | | | | | |
| Catalyst | 1.00 | 1.00 | 0.80 | 1.00 | |

TABLE 5
Properties of Examples 1-5 (embodiments of current invention).

| | Ex. 1 | Ex. 2 | Ex. 3 | Ex. 4 | Ex. 5 |
|---|---|---|---|---|---|
| Slump (mm) | 5 | 107 | ~20 | ~20 | ~20 |
| Curing time at low | ~12 h | ~12 h | ~24 h | ~24 h | ~12-24 h |
| temperature (5° C.) | | | | | |
| Plasticizer migration at | No change | No change | Migration | No change | No change |
| 60° C. | after 4 | after 4 | after 1 | after 4 | after 4 |
| | weeks | weeks | day | weeks | weeks |
| Peel adhesion to dry | 1.38 | 0.66 | 0.23 | 0.28 | 1.67 |
| concrete at 23° C. | (coh) | (coh) | (adh) | (adh) | (coh) |
| (N/mm) | | | | | |
| Peel adhesion to damp | 1.30 | 1.18 | 0.74 | 1.5 | 0.97 |
| concrete at 23° C. | (coh) | (coh) | (coh) | (coh) | (coh) |
| (N/mm) | | | | | |
| Pull off adhesion to dry | 0.974 | | | | |
| concrete at 23° C. | (coh/adh) | | | | |
| (N/mm) | | | | | |
| Pull off adhesion to | 0.986 | | | | |
| damp concrete at 23° C. | (coh/adh) | | | | |
| (N/mm) | | | | | |
| Peel adhesion to dry | 0.387 | 0.2 | 0.23 | 0.23 | 1.47 |
| concrete at 23° C. after | (adh) | (adh) | | | (coh) |
| 28-day water | | | | | |
| immersion (N/mm) | | | | | |
| Peel adhesion to damp | 0.817 | 1.24 | 0.74 | 1.19 | 0.73 |
| concrete at 23° C. after | (coh) | (coh) | | | (coh) |
| 28-day water | | | | | |
| immersion (N/mm) | | | | | |
| Peel adhesion to dry | | 0.256 | | | |
| concrete @ 23° C. after | | (adh) | | | |
| 3-month water | | | | | |
| immersion (N/mm) | | | | | |
| Peel adhesion to damp | | 0.56 | | | |
| concrete @ 23° C. after | | (coh) | | | |
| 3-month water | | | | | |
| immersion (N/mm) | | | | | |
| Peel adhesion to HDPE | 0.87 | 0.9 | 1.06 | | |
| at 23° C. (N/mm) | | | | | |
| Peel adhesion to HDPE | 0.5-1.0 | 0.5-1.0 | 0.2-1.5 | | |
| at 23° C. after 28-day | | | | | |
| water immersion | | | | | |
| (N/mm) | | | | | |
| Peel adhesion to HDPE | | 0.3-1.0 | | | |
| at 23° C. after 3-month | | | | | |
| water immersion | | | | | |
| (N/mm) | | | | | |
| Water absorption after | ~0-5% | 4.50% | | 4.90% | 1.40% |
| 40 days | | | | | |

### Example 6 (Other Exemplary Embodiments)

In further exemplary embodiments, which may be based on any of the foregoing enumerated embodiments in the above detailed description, compositions of the invention may be formulated to influence water absorption and adhesion properties favorably (e.g., after water immersion), based on parts by total weight of components as follows: a modified silane (MS) polymer (e.g., Kaneka SAX 750), preferably in the amount of 2.0-50.0, more preferably in the amount of 2-30, and most preferably in the amount of 7-15; a silyl terminated polyether (STPE) polymer (e.g., Wacker Geniosil® WP 1) preferably in the amount of 2.0-50.0, more preferably in the amount of 2-30, and most preferably in the amount of 7-15; a polyol with molecular weight average of 2000 (e.g., CARADOL ED56-200 (PPG 2000) available from Shell, or Petol® 56-2LM available from Harke) preferably in the amount of 2.0-60.0, more preferably in the amount of 2-50, and most preferably in the amount of 10-20; and a plurality of adhesion promoters: e.g., Evonik Dynasylan™ 1146, preferably in the amount of 0.1-2.0, more preferably in the amount of 0.3-1.0, and most preferably in the amount of 0.6-0.7; Evonik Dynasylan™ GLYMO, preferably in the amount of 0.1-3.0, more preferably in the amount of 0.1-0.8, and most preferably in the amount of 0.3-0.5; and Evonik Dynasylan™ OCTMO, preferably in the amount of 0.1-5.0, more preferably in the amount of 0.5-3.0, and most preferably in the amount of 1.0-2.0.

Preferred optional additives can be incorporated with the above polymer and adhesion promoter components in the following preferred amounts if desired: ground calcium carbonate filler, preferably, in the amount of 2.0-60, more preferably in the amount of 10-60, and most preferably in the amount of 35-45; high-purity silica, preferably, in the amount of 5.0-60, more preferably in the amount of 5.0-40.0, and most preferably in the amount of 15-25; pigment, preferably in the amount of 0.1-5.0, more preferably in the amount of 0.1-1.0, and most preferably in the amount of 0.1-0.3; rheology modifier (e.g., amide wax) preferably in the amount of 0.1-5.0, more preferably in the amount of 0.1-3.0, and most preferably in the amount of 1.0-2.0; a light stabilizer (e.g., HALS), preferably in the amount of 0.1-1.0, more preferably in the amount of 0.1-0.5, and most preferably in the amount of 0.3-0.4; UV absorber, preferably in the amount of 0.1-2.0, more preferably in the amount of 0.1-1.0, and most preferably in the amount of 0.5-0.7; an antioxidant, preferably in the amount of 0.1-2.0, more preferably in the amount of 0.1-0.6, and most preferably in the amount of 0.1-0.3; a moisture scavenger, preferably in the amount of 0.1-3.0, more preferably in the amount of 0.1-1.0, and most preferably in the amount of 0.3-0.5; and a catalyst, preferably in the amount of 0.1-4.0, more preferably in the amount of 0.2-2.0, and most preferably in the amount of 0.5-1.5.

The foregoing examples and embodiments were present for illustrative purposes only and not intended to limit the scope of the invention.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

What is claimed is:

1. A moisture-cured non-aqueous waterproofing paste composition, comprising:
a first silyl-terminated reactive polymer resin;
a second silyl-terminated reactive polymer resin, wherein the first silyl-terminated reactive polymer resin has a different chemical structure from the second silyl-terminated reactive polymer resin; and
a plurality of adhesion promoters, each including a functional silane, wherein a first adhesion promoter of the plurality of adhesion promoters comprises a hydrophobic diaminofunctional silane;
wherein the composition, upon curing, has a water absorption of about 15% or less after about 40 days of water immersion.

2. The composition of claim 1 wherein the composition has a slump between 0 and 20 mm prior to curing, more preferably a slump between 0 and 10 mm prior to curing; and most preferably a slump between 0 and 5 mm prior to curing, the slump being determined in accordance with ASTM D 2202-00 (2019).

3. The composition of claim 1, wherein the first silyl-terminated polymer resin comprises a dimethoxy silyl type, modified-silicone polyether polymer in an amount of about 2-40% by weight of the composition.

4. The composition of claim 1, wherein the second silyl-terminated polymer resin is a reactive silane terminated polyether polymer in an amount of about 2-40% by weight of the composition, wherein the reactive silane terminated polyether polymer is characterized by structural proximity of a nitrogen atom to a silicon atom in the dimethoxy(methyl)silyl-methylcarbamate group.

5. The composition of claim 1, wherein the plurality of adhesion promoters is present in an amount above 0% and below about 5% by weight of the composition.

6. The composition of claim 1, wherein the plurality of adhesion promoters comprises:
a second adhesion promoter comprising a monomeric alkylfunctional silane, and
a third adhesion promoter comprising a bifunctional organosilane.

7. The composition of claim 5, wherein the monomeric alkylfunctional silane comprises octyltrimethoxysilane.

8. The composition of claim 5, wherein the bifunctional organosilane comprises 3-glycidyloxypropyltrimethoxysilane having a reactive organic epoxide group and a hydrolysable inorganic methoxysilane group.

9. The composition of claim 1, further comprising a plasticizer comprising polypropylene glycol.

10. The composition of claim 1, further comprising fillers chosen from ground calcium carbonate, high-purity silica, or a combination thereof.

11. The composition of claim 1, further comprising additives chosen from inhibitors, pigments, anti-settlement aids, rheology modifiers (e.g., amide wax rheology modifiers), light stabilizers (e.g., HALS), UV absorbers, degassers, antistatic agents, antioxidants, moisture scavengers, accelerants, stabilizers, fire retardants, pH adjusters, reinforcing agents, thickening or thinning agents, elastic compounds, chain transfer agents, radiation absorbing or reflecting compounds, or a combination thereof.

12. The composition of claim 1, further comprising a catalyst.

13. The composition of claim 1, wherein the composition has the following properties:
peel adhesion to dry concrete at 23° C. between about 0.6 N/mm and about 2.0 N/mm as determined according to ASTM D 903-98 (2017)(modified), and
peel adhesion to damp concrete at 23° C. between about 0.6 N/mm and about 2.0 N/mm as determined according to ASTM D 903-98 (2017)(modified)

14. The composition of claim 1, wherein the composition has a cure time at 5° C. under about 24 hours.

15. The composition of claim 1, wherein the composition has no observable plasticizer migration upon curing within four (4) weeks of contact and stored at +60° C.

16. The composition of claim 1, wherein the water absorption of the composition, upon curing, is about 10% or less after about 40 days of water immersion.

17. The composition of claim 1, wherein the water absorption of the composition, upon curing, is about 5% or less after about 40 days of water immersion.

18. The composition of claim 1, wherein the composition has the following properties:
peel adhesion to dry concrete at 23° C. after about 28-day water immersion between about 0.2 N/mm and about 2.0 N/mm as determined according to ASTM D 903-98 (2017)(modified); and
peel adhesion to damp concrete at 23° C. after about 28-day water immersion between about 0.2 N/mm and about 2.0 N/mm as determined according to ASTM D 903-98 (2017)(modified).

19. A waterproofing paste, comprising: at least one silyl-terminated polymer resin and a plurality of adhesion promoters, wherein the paste has the following properties:
a cure time at 5° C. under about 24 hours;
peel adhesion to damp concrete at 23° C. between about 0.6 N/mm and about 2.0 N/mm as determined according to ASTM D 903-98 (2017)(modified); and
a water absorption of about 30% or less after about 40 days of water immersion.

20. The waterproofing paste of claim 19 wherein the paste has a slump between 0 and 20 mm prior to curing, more preferably a slump between 0 and 10 mm prior to curing; and most preferably a slump between 0 and 5 mm prior to curing, the slump being determined in accordance with ASTM D 2202-00 (2019).

21. The waterproofing paste of claim 20, wherein the paste has peel adhesion to dry concrete at 23° C. between about 0.6 N/mm and about 2.0 N/mm as determined according to ASTM D 903-98 (2017)(modified).

22. The waterproofing paste of claim 20, wherein the paste has peel adhesion to a corona treated HDPE substrate at 23° C. between about 0.6 N/mm and about 2.0 N/mm as determined according to ASTM D 1876 08 (2015).

23. The waterproofing paste of claim 20, wherein the paste has peel adhesion to a corona treated HDPE substrate at 23° C. after about 28-day water immersion between about 0.2 N/mm and about 2.0 N/mm as determined according to ASTM D 1876 08 (2015).

24. The waterproofing paste of claim 20, wherein the paste has peel adhesion to a corona treated HDPE substrate at 23° C. after about 3-month water immersion between about 0.2 N/mm and about 2.0 N/mm as determined according to ASTM D 1876 08 (2015).

25. The waterproofing paste of claim 20, wherein the paste has the following properties:
peel adhesion to dry concrete at 23° C. after about 28-day water immersion between about 0.2 N/mm and about 2.0 N/mm as determined according to ASTM D 903-98 (2017)(modified), and
peel adhesion to damp concrete at 23° C. after about 28-day water immersion between about 0.2 N/mm and about 2.0 N/mm as determined according to ASTM D 903-98 (2017)(modified).

26. The waterproofing paste of claim 20, wherein the water absorption of the paste, upon curing, is about 15% or less after about 40 days of 908 immersion.

27. The waterproofing paste of claim 20, wherein the water absorption of the paste, upon curing, is about 10% or less after about 40 days of water immersion.

28. The waterproofing paste of claim 20, wherein the water absorption of the paste, upon curing, is about 5% or less after about 40 days of water immersion.

29. The waterproofing paste of claim 20, wherein each of the plurality of adhesion promoters includes a functional silane.

30. The waterproofing paste of claim 20, wherein the at least one silyl-terminated polymer resin comprises at least a pair of silane terminated polyether polymers.

31. The waterproofing paste of claim 20, further comprising a plasticizer comprising polypropylene glycol.

32. The waterproofing paste of claim 20, wherein the plurality of adhesion promoters comprises:
a first adhesion promoter comprising a hydrophobic diaminofunctional silane,
a second adhesion promoter comprising a monomeric alkylfunctional silane, and
a third adhesion promoter comprising a bifunctional organosilane.

33. The paste of claim 20, further comprising fillers chosen from ground calcium carbonate, high-purity silica, or a combination thereof.

34. The paste of claim 20, further comprising additives chosen from inhibitors, pigments, anti-settlement aids, rheology modifiers (e.g., amide wax rheology modifiers), light stabilizers (e.g., HALS), UV absorbers, degassers, antistatic agents, antioxidants, moisture scavengers, accelerants, stabilizers, fire retardants, pH adjusters, reinforcing agents, thickening or thinning agents, elastic compounds, chain transfer agents, radiation absorbing or reflecting compounds, or a combination thereof.

35. The paste of claim 20, further comprising a catalyst.

36. A method of waterproofing a substrate, comprising applying the composition of claim 1 to a building substrate and allowing the composition to cure.
